(19) United States
(12) Patent Application Publication
(10) Pub. No.: US 2018/0161788 A1
(43) Pub. Date: Jun. 14, 2018

(54) WATER JETTING NOZZLE

(71) Applicant: Sewerquip Pty Ltd, St. Marys NSW (AU)

(72) Inventor: Brent Wiggins, St Marys (AU)

(21) Appl. No.: 15/375,659

(22) Filed: Dec. 12, 2016

(51) Int. Cl. B05B 3/04; B05B 3/18; B08B 9/04

(52) U.S. Cl. CPC B05B 3/0463; B08B 9/04; B05B 3/18

(57) ABSTRACT

A water jetting nozzle includes a housing assembly and a hollow shaft extending longitudinally within the housing assembly and having a shaft proximal end adapted to be connected in fluid communication with a high pressure water line, and a shaft distal end. A rotating head is secured to the shaft distal end, the rotating head including at least one water jet orifice. A magnetic rotor is seated on the shaft and a conductor sleeve is located within the housing assembly, the conductor sleeve having a longitudinally extending bore adapted to receive the magnetic rotor. A longitudinal position of the conductor sleeve is selectively movable relative to the magnetic rotor between a first position in which the magnetic rotor is generally located within the bore, and a second position in which the magnetic rotor is at least partially external of the bore.

### TECHNICAL FIELD

The present disclosure relates to a water jetting nozzle. In particular, the present invention relates to a water jetting nozzle for use within pipes and conduits and other applications.

### BACKGROUND

Water jetting nozzles can be deployed in various applications. One such application concerns the removal of blockages or obstructions from pipes, drains and other plumbing conduits. Over time, conduits may become restricted on account of sediment, calcium build up, grease and other such material which accumulates on the internal the wall of the pipe. As the restriction increases in size, the cross sectional area of the pipe is reduced, and eventually the required flow rate though the pipe may be compromised.

One particularly common cause of pipe blockage results from tree roots and other such plant matter growing into the pipe. This may occur in the vicinity of connections between adjacent pipe sections, or where there is damage to the pipe. Tree roots are also known to penetrate small cracks in earthenware/terracotta pipes.

Mechanical cleaners can be used to remove obstructions in pipes. Mechanical cleaners such as “electric eels” have a cutting head which is fed into the pipe to cut away the obstruction. However, these mechanical cleaners are known to become blocked in some situations, for example when the conduit includes numerous bends, or when the distance from the inspection opening to the blockage is large. Electric eels are known to become caught by some plumbing infrastructure such as traps and gullies, or other such joins in the line. In such scenarios, it can become difficult to guide the electric eel to the desired location of the obstruction.

High power water jetting provides an alternative for the removal of obstructions in a pipe. A high power nozzle delivers water at a speed and force which is sufficient to cut through root matter and clean out other debris such as grease, solid waste and silt.

Depending on the type of blockage that requires removal, the technician may require different nozzles, or alternatively an adjustment of the water flow rate and other settings of the nozzle may be required. For example, the rotation speed of the nozzle may be selectively varied to provide different blockage removal characteristics. Typically low rotation speeds are preferable for tree root cutting, whilst faster rotation speeds are more suitable for the removal of grease and silt.

With existing water jetting nozzles, it is generally difficult for a user to make adjustments to the rotational speed of the nozzle. In order to make such adjustments, the nozzle typically requires partial disassembly which takes up valuable operator time and leaving the nozzle vulnerable to contamination due to the dirty working environment these nozzles are generally used in.

There is also a risk of increased wear and tear on the components if the nozzle is repeatedly disassembled and rebuilt. This may reduce the working life of the nozzle, and require more frequent servicing and maintenance.

It is an object of the present invention to substantially overcome or at least ameliorate one or more of the above disadvantages, or to provide a useful alternative.

### SUMMARY

In a first aspect, the present invention provides a water jetting nozzle comprising:

a housing assembly;

a hollow shaft extending longitudinally within the housing assembly and having a shaft proximal end adapted to be connected in fluid communication with a high pressure water line, and a shaft distal end;

a rotating head secured to the shaft distal end, the rotating head including at least one water jet orifice;

a magnetic rotor seated on the shaft; and

a conductor sleeve located within the housing assembly, the conductor sleeve having a longitudinally extending bore adapted to receive the magnetic rotor;

wherein a longitudinal position of the conductor sleeve is selectively movable relative to the magnetic rotor between a first position in which the magnetic rotor is generally located within the bore, and a second position in which the magnetic rotor is at least partially external of the bore.

The water jetting nozzle preferably further comprises an adjustment ring secured to the housing assembly, the adjustment ring being adapted to selectively alter the longitudinal position of the conductor sleeve relative to the magnetic rotor.

The adjustment ring is preferably secured to a stator screw located within the housing assembly, and the stator screw is adapted to longitudinally displace the conductor sleeve.

An internal surface of the stator screw preferably includes a female thread which engages with a corresponding male thread formed on an outer surface of the conductor sleeve.

The conductor sleeve preferably includes a radially outwardly extending spline adapted to be received by a corresponding longitudinally extending keyway formed on an internal, circumferential surface of the housing assembly.

A plurality of permanent magnets are preferably located around the circumference of the magnetic rotor.

The magnetic rotor is preferably fabricated from aluminium and the conductor sleeve is fabricated from copper.

A seal is preferably located between the housing assembly and the adjustment ring.

### BRIEF DESCRIPTION OF THE DRAWINGS

A preferred embodiment of the invention will now be described by way of specific example with reference to the accompanying drawings, in which:

FIG. 1 is an exploded assembly view depicting the water jetting nozzle according to the invention;

FIG. 2 is a side view of the water jetting nozzle according to FIG. 1;

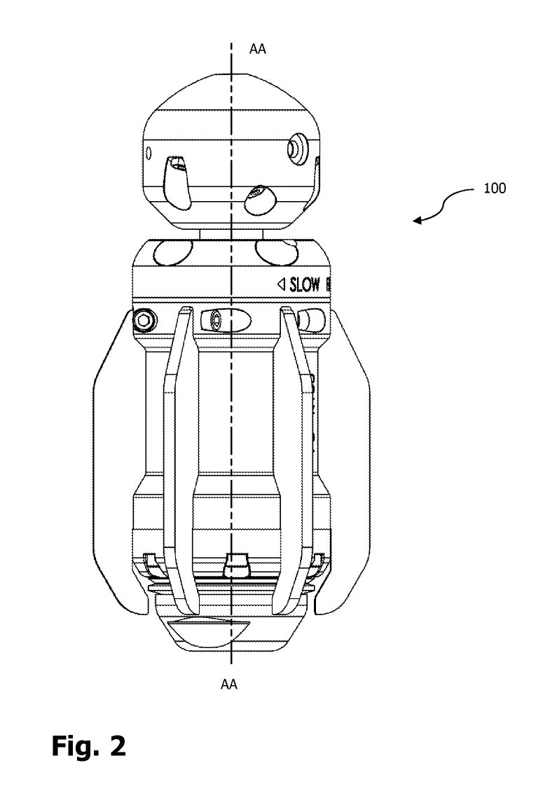

FIG. 3 is a perspective front view of the water jetting nozzle according to FIG. 1; and

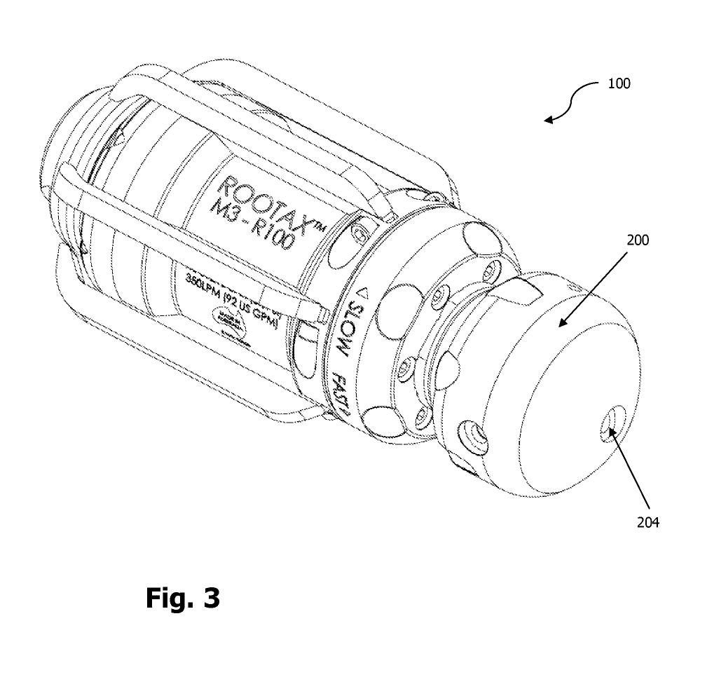

FIG. 4 is a cross-sectional side view of the water jetting nozzle of FIG. 1.

FIG. 5 is a cross-sectional view showing a water jetting nozzle according to a second embodiment of the invention.

### DETAILED DESCRIPTION

A water jetting nozzle 100 is disclosed herein. The nozzle 100 includes a rotating head 200 which is located at a leading end of the nozzle 100. The rotating head 200 is fabricated from stainless steel or another suitable engineering material. The rotating head 200 includes a plurality of rearwardly and radially and outwardly facing water jet orifices 202. The water jet orifices 202 provide both thrust and rotating power. Rotational force is generated because the water jet orifices 202 are angularly inclined relative to a longitudinal axis AA.

The rotating head 200 further includes a generally forward facing water jet orifice 204 which is located on the longitudinal axis AA of the water jetting nozzle 100. However, the forward facing water jet orifice 204 is also angularly inclined, so that the direction of the water jet is non-axial, but in contrast defines a conic form during a complete revolution of the rotating head 200.

The rotating head 200 is located adjacent to an adjustment ring 300, which defines a front portion of the housing 220. The adjustment ring 300 can be selectively rotated about the longitudinal axis AA of the water jetting nozzle 100. By rotating the adjustment ring 300 in a first direction, the rotational speed of the rotating head 200 can be increased. In contrast, by rotating the adjustment ring 300 in an opposing, second direction, the rotational speed of the rotating head 200 can be decreased. This process is described in more detail below.

A Teflon or other such suitable seal 324 is positioned between the adjustment ring 300 and the housing 400, to prevent the ingression of contaminants into the housing 400.

The water jetting nozzle 100 includes a housing 400. The housing 400 includes a plurality of longitudinally extending fins 402. In the embodiment depicted in the figures, there are 6 fins evenly spaced around the circumference of the body 400. However, it will be appreciated that a different number of fins 402 may be utilised. The fins 402 assist to locate the nozzle head 100 within a generally central portion of the conduit (not shown) for optimal water jetting.

A stator screw 500 is seated within the housing 400. The stator screw 500 is fabricated from stainless steel. An internal surface of the stator screw 500 includes a female thread 502.

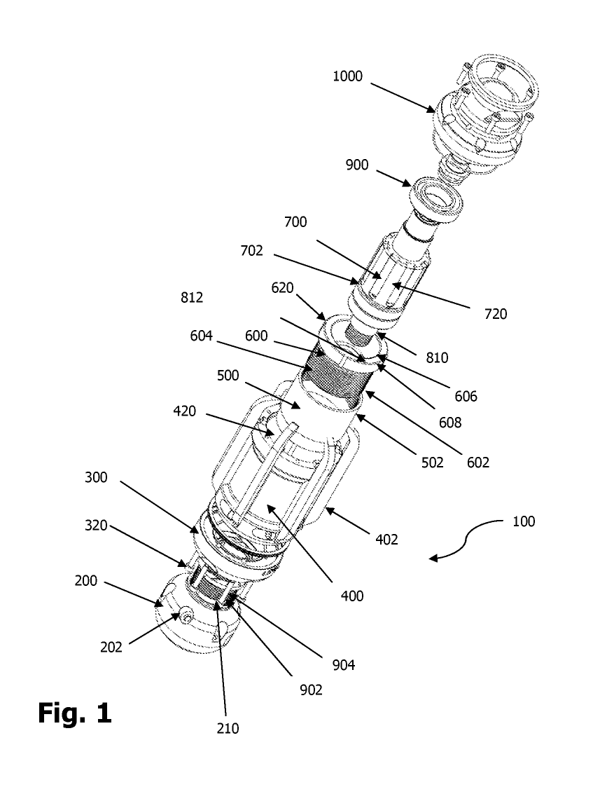

A copper (or other electrically conductive) conductor sleeve 600 is seated within the stator screw 500. As depicted in the exploded perspective view of FIG. 1, the copper conductor sleeve 600 is fabricated with an external male thread 602 formed on a radial outer surface 604. The male thread 602 corresponds with and is adapted to engage with the female thread 502.

The copper conductor sleeve 600 includes a flange 608, which is approximately the same diameter as the outer surface of the stator screw 500. A tooth or spline 620 radially extends away from the flange 608, beyond the outer diameter of the copper conductor sleeve 600. The spline 620 mates with a corresponding keyway or channel 420 which extends longitudinally within the housing 400, parallel to the longitudinal axis AA. The interaction between the spline 620 and the keyway 420 prevents the copper conductor sleeve 600 from rotating relative to the housing 400.

A plurality of screws 320 extend through holes 322 formed in the adjustment ring 300, and engage with the stator screw 500. The screws 320 act to secure the stator screw 500 to the adjustment ring 300.

The nozzle head 100 includes a magnetic rotor 700. The magnetic rotor 700 includes a rotor body 702 fabricated from aluminium, which is seated on and adapted to rotate with a stainless steel shaft 810.

There are eight permanent magnets 720 which are radially positioned, generally evenly around the circumference of the rotor body 702. The rotor magnets 720 are depicted as an assembly of eight rotor magnets 720. However, it will be appreciated that more or less than eight magnets may be utilised.

The magnetic rotor 700 and copper conductor sleeve 600 together define an eddy current braking device 705. The amount of braking force which is applied is a function of the proportion of the magnetic rotor 700 which is located within a longitudinally extending central bore 606 formed within the copper conductor sleeve 600. Eddy currents are generated which apply opposing magnetic force against the rotating magnets 720, and hence the shaft 810 (which is rotationally secured to the rotor body 702). The greater the rotational speed the more opposing force is applied, meaning this type of braking device 700 is suitable for a wide range of pressures and flow rates.

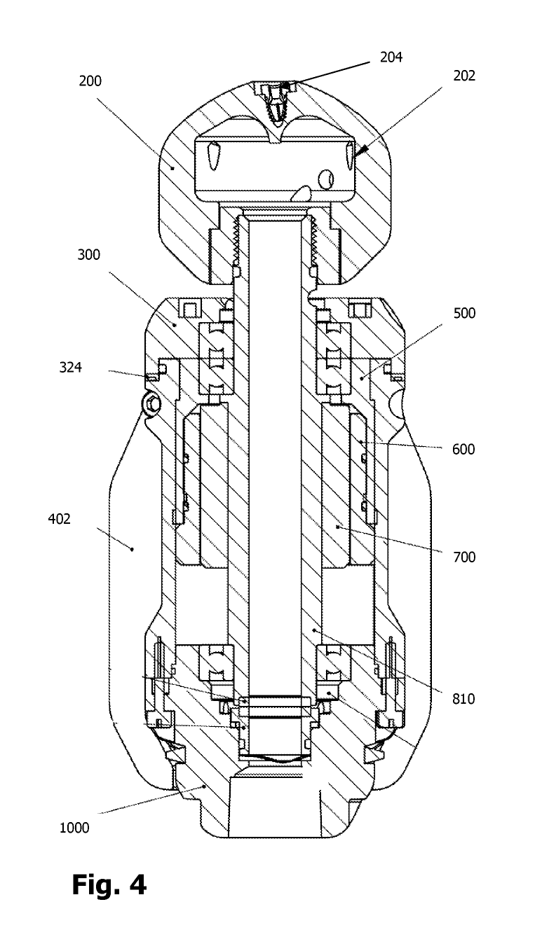

As depicted in the cross-sectional view of FIG. 4, the shaft 810 has a leading, male threaded portion 812. The thread 812 is received by a corresponding female thread 210 formed within a nozzle adaptor 220 secured to the rotating head 200. As such, the shaft 810 and the rotating head 200 are rotationally interconnected, along with the braking device 705 which is seated on the shaft 810.

A first bearing 900 is seated on the shaft 810 on the trailing side of the magnetic rotor 700. A second pair of bearings 902, 904 is also seated on the shaft 810, on a leading side of the housing 400. Bearing 904 acts as a seat for the adjustment ring 300, and bearing 902 acts as a seat for stator screw 500, and also the housing 400, which radially encompasses the stator screw 500.

The copper conductor sleeve 600 can be moved axially within the housing 400 toward or away from the rotating head 200. This is achieved by rotating the adjustment ring 300. By rotating the adjustment ring 300, the copper conductor sleeve 600 is moved axially toward or away from the rotating head 200. By positioning the copper sleeve relative to the magnets 720, the eddy current breaking power is altered accordingly making the nozzle head 100 spin faster or slower.

A rear housing 1000 is adapted to be secured to a high power water line (not shown). The rear housing 1000 is seated on the bearing 900, and the rear housing 1000 is secured to the housing 400 with screws 1002. The rear housing 1000 and housing 400 together define a housing assembly.

During use, the rear housing 900, the housing 400, the adjustment ring 300, the stator screw 500 and the copper conductor sleeve 600 are rotationally isolated. In contrast, the rotating head 200, the shaft 800 and the magnetic rotor 700 are rotationally free.

A nozzle adaptor 220 is located between the rotating head 200 and the shaft 810.

The operation of the water jetting nozzle 100 will now be described. When a user wishes to vary the rotation rate of the rotating head 200, the user pivots the adjustment ring 300 about the longitudinal axis AA. This results in the interconnected stator screw 500 also pivoting. The stator screw 500 also attempts to rotate the copper conductor sleeve 600. However, the interaction between the spline 620 and the corresponding keyway or channel 420 prevents the rotation of the copper conductor sleeve 600. Accordingly, the copper conductor sleeve 600 is urged to move longitudinally within the housing 400, on account of interaction between the stator screw thread 502 and the copper conductor thread 602.

Accordingly, the longitudinal position of the conductor sleeve 600 is selectively movable relative to the magnetic rotor 700 between a first position in which the magnetic rotor 700 is generally located within the bore 606, and a second position in which the magnetic rotor 700 is at least partially external of the bore 600. In addition, the conductor sleeve can be set in an intermediate position between the first and second positions.

In the operational position depicted in FIG. 4, maximum braking force is applied, as the copper conductor sleeve 600 generally encompasses the magnetic rotor 700. This represents a slow rotational speed configuration, corresponding to a large eddy current. This configuration may be used for example to cut tree roots.

In contrast, if the copper conductor sleeve 600 is moved longitudinally, such that it only partially encompasses the magnetic rotor 700, less eddy current is applied, and hence less braking force is generated, resulting is a higher rotational speed of the rotating head 200. This configuration could be used for example to remove grease.

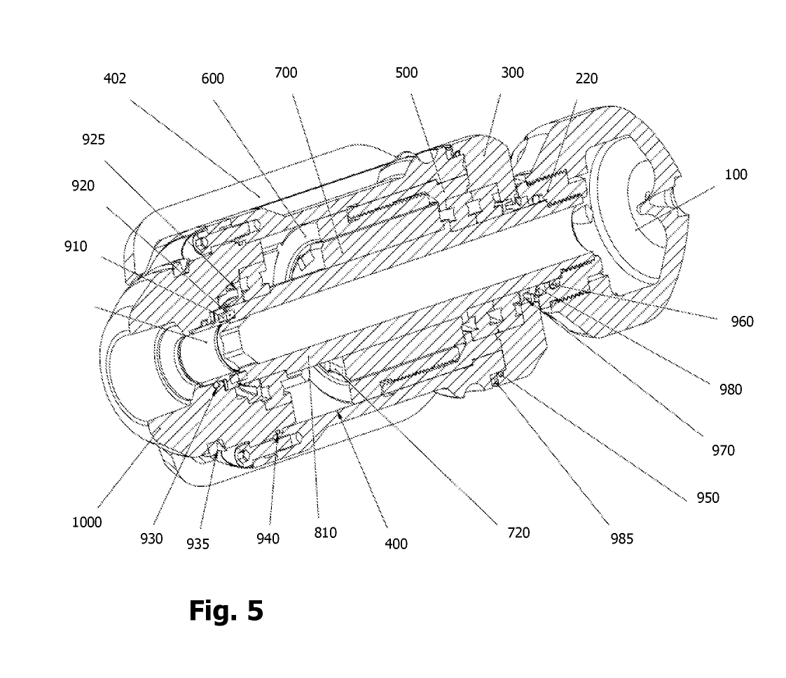

A second embodiment of the water jetting nozzle 100 is disclosed in FIG. 5. In that embodiment, like reference numerals are used to designate features which are common with the first embodiment.

The second embodiment of the water jetting nozzle 100 is operationally similar with the exception that, there are variations in the seal arrangements. In particular, the seals 910, 920 located between the rear housing 1000 and the shaft 810 have been changed from ceramic seals to nickel bonded tungsten carbide seals 910, 920 with dissimilar lapped faces. Furthermore, hydraulic closing/opening forces on the seals have been balanced to allow more media lubrication between seal faces to increase the life of the seals 910, 920. The Tungsten carbide seals are secured using a shrink fit to mechanically lock the seals 910, 920 in place and an epoxy is placed on the reverse face to seal up to 350 bar.

As shown in FIG. 5, O-rings and other seals are positioned at various locations within the water jetting nozzle 100. For example, an O-ring 930 is positioned between the rear housing 1000 and the shaft 810. An O-ring 940 is positioned between the rear housing 1000 and the main housing 400. An O-ring 950 is positioned between the main housing 400 and the adjustment ring 300. An O-ring 960 is positioned between the shaft 810 and the nozzle adaptor 220. Furthermore, an oil seal 970 is positioned between the adjustment ring 300 and the shaft 810. A V-ring seal 980 is positioned between the nozzle adaptor 220 and the shaft 810. A rubber oil seal 925 is located between the shaft 810 and the rear housing 1000. A V-ring seal 935 is located on the rear housing 1000. A Polyurethane seal 985 is located between the main housing 400 and the adjustment ring 300.

Advantageously, the rotational speed of the rotating head 200 can easily be adjusted on site to suit a wide range of cleaning applications (eg, slow for tree root cutting, medium for pipe wall scrubbing and fast for grease removal).

Advantageously, the rotational speed of the water jetting nozzle 100 can be adjusted without any disassembly.

Although the invention has been described with reference to specific examples, it will be appreciated by those skilled in the art that the invention may be embodied in many other forms.

1. A water jetting nozzle comprising:
a housing assembly;
a hollow shaft extending longitudinally within the housing assembly and having a shaft proximal end adapted to be connected in fluid communication with a high pressure water line, and a shaft distal end;
a rotating head secured to the shaft distal end, the rotating head including at least one water jet orifice;
a magnetic rotor seated on the shaft; and
a conductor sleeve located within the housing assembly, the conductor sleeve having a longitudinally extending bore adapted to receive the magnetic rotor;
wherein a longitudinal position of the conductor sleeve is selectively movable relative to the magnetic rotor between a first position in which the magnetic rotor is generally located within the bore, and a second position in which the magnetic rotor is at least partially external of the bore.

2. The water jetting nozzle of claim 1, further comprising an adjustment ring secured to the housing assembly, the adjustment ring being adapted to selectively alter the longitudinal position of the conductor sleeve relative to the magnetic rotor.

3. The water jetting nozzle of claim 2, wherein the adjustment ring is secured to a stator screw located within the housing assembly, and the stator screw is adapted to longitudinally displace the conductor sleeve.

4. The water jetting nozzle of claim 3, wherein an internal surface of the stator screw includes a female thread which engages with a corresponding male thread formed on an outer surface of the conductor sleeve.

5. The water jetting nozzle of claim 4, wherein the conductor sleeve includes a radially outwardly extending spline adapted to be received by a corresponding longitudinally extending keyway formed on an internal, circumferential surface of the housing assembly.

6. The water jetting nozzle of claim 1, wherein a plurality of permanent magnets are located around the circumference of the magnetic rotor.

7. The water jetting nozzle of claim 6, wherein the magnetic rotor is fabricated from aluminium and the conductor sleeve is fabricated from copper.

8. The water jetting nozzle of claim 2, wherein a seal is located between the housing assembly and the adjustment ring.

9. The water jetting nozzle of claim 1, wherein the longitudinal position of the conductor sleeve can be selectively set at one or more intermediate locations between the first position and the second position.

10. The water jetting nozzle of claim 1, wherein one or more seals is located between a rear housing of the housing assembly and the hollow shaft, the seal(s) being fabricated from tungsten carbide.
